(19) United States
(12) Patent Application Publication
(10) Pub. No.: US 2023/0119988 A1
(43) Pub. Date: Apr. 20, 2023

(54) METHOD FOR DISPLAYING A HORIZONTAL DISTANCE OF A MOTOR VEHICLE FROM A LANE BOUNDARY

(71) Applicant: HELLA GmbH & Co. KGaA, 18082000 (DE)

(72) Inventors: Christian HUESTER, Salzkotten (DE); Boris KUBITZA, Moehnesee-Koerbecke (DE)

(73) Assignee: HELLA GmbH & Co. KGaA, Lippstadt (DE)

(21) Appl. No.: 18/082,000

(22) Filed: Dec. 15, 2022

Related U.S. Application Data
(63) Continuation of application No. PCT/EP2021/064229, filed on May 27, 2021.

(30) Foreign Application Priority Data
Jun. 16, 2020 (DE) 10 2020 115 775.4

(51) Int. Cl. B60Q 1/50; B60Q 1/04; B60Q 1/00; G06V 20/56

(52) U.S. Cl. CPC B60Q 1/50; B60Q 1/04; B60Q 1/0023; G06V 20/588; B60Q 2400/50

(57) ABSTRACT

A method for displaying a horizontal distance of a motor vehicle from a lane boundary, comprising the following steps: determining the horizontal distance of the motor vehicle from the lane boundary; and projecting a numerical value by means of a headlight of the motor vehicle, wherein the numerical value depends on the determined horizontal distance, or projecting a marking, wherein a width of the marking depends on the determined horizontal distance.

This nonprovisional application is a continuation of International Application No. PCT/EP2021/064229, which was filed on May 27, 2021, and which claims priority to German Patent Application No. 10 2020 115 775.4, which was filed in Germany on Jun. 16, 2020, and which are both herein incorporated by reference.

### BACKGROUND OF THE INVENTION

### Field of the Invention

The present invention relates to a method for displaying a horizontal distance of a motor vehicle from a lane boundary.

### Description of the Background Art

Methods are known from the state of the art in which markings are projected onto a roadway in front of the motor vehicle by means of a motor vehicle headlight; these are intended to assist the motor vehicle driver in keeping the motor vehicle within lane boundaries.

It is known from DE 10 2006 048 503 A1 to project a light marking onto the roadway in front of the motor vehicle. The light marking runs parallel to the longitudinal axis of the vehicle, is laterally limited, and corresponds to a predetermined width in terms of the distance of its lateral boundaries.

### SUMMARY OF THE INVENTION

It is therefore an object of the present invention to make it easier for a vehicle driver, especially in relatively narrow lanes, to guide the motor vehicle within the lane boundaries.

The horizontal distance of the motor vehicle from the lane boundary is determined. The lane boundary can be, for example, a road marking or a road edge. In the context of this description, the horizontal distance cam be understood to mean in particular the distance in the horizontal direction only. Thus, for example, when measuring the distance between a motor vehicle component which does not touch the ground when the vehicle is moving, e.g., an exterior mirror or door, and the lane boundary, a vertical distance between the component and the lane boundary is not considered.

The horizontal distance of the motor vehicle from the lane boundary can be determined using a camera and a control unit, for example. The camera can record video or image data from the surroundings of the motor vehicle, for example, from the roadway located in front of the motor vehicle, and output these video or image data to the control unit. The control unit can be designed to determine the horizontal distance from these video or image data.

The determined horizontal distance is projected as a numerical value by means of a headlight of the motor vehicle, for example, onto the roadway located in front of the motor vehicle. Thus, the driver of the motor vehicle is always shown an exact numerical value of how far his motor vehicle is from the lane boundary in the horizontal direction. This is easier for many people to grasp than, for example, estimating how far a projected line is from the lane boundary.

As an alternative to projecting the numerical value, a marking can be projected. Here, a width of the marking depends on the determined horizontal distance. For example, the further the motor vehicle is from the lane boundary, the wider the marking can be. In the context of this description, width is understood to mean, in particular, the direction in the horizontal direction perpendicular to the direction in which the motor vehicle is moving. The width can be the direction in which the determined horizontal distance also extends.

Adapting the width of the marking to the determined horizontal distance is particularly advantageous for a user of the motor vehicle, as he can thus detect particularly quickly whether he is sufficiently far away from the lane boundary.

The horizontal distance between a lateral end of the motor vehicle and the lane boundary can be determined. The lateral end can be defined by a specific component, for example. This can be, for example, an exterior mirror, a body part, a door, or a wheel.

The numerical value can correspond to the determined distance in meters.

The projection can be made onto a roadway located in front of the motor vehicle. In this case, the lane can be delimited by the lane boundary. In particular, this can be understood to mean that the projection is made in a direction that corresponds to the direction of travel of the motor vehicle.

According to an example, only the horizontal distance of the motor vehicle from the lane boundary can be determined. This can mean that a vertical distance is not taken into account.

The width of the marking can correspond to the determined horizontal distance. In this way, a user of the motor vehicle can see especially easily from the width of the marking how far the motor vehicle is from the lane boundary.

In particular, it is possible for the markings to each be arranged laterally offset relative to the motor vehicle. Thus, they can be located in front of the motor vehicle and fill the areas that lie between the motor vehicle and the lane boundaries when the motor vehicle is traveling straight ahead.

A further horizontal distance of the motor vehicle from a further lane boundary can be determined. A further numerical value can then be projected by means of the headlight or by means of a further headlight of the motor vehicle. The further numerical value depends on the determined further horizontal distance. In particular, it is possible that all embodiments in this description regarding the horizontal distance, the numerical value, and the headlight apply completely or partially analogously to the further numerical value, the further horizontal distance, and the further lane boundary.

This example is especially advantageous for particularly narrow lanes. A driver of the motor vehicle can keep the motor vehicle particularly easily centered within the lane by taking care that both numerical values are approximately the same.

A further horizontal distance of the motor vehicle from a further lane boundary can be determined. A further marking can be projected by means of the headlight or by means of a further headlight of the motor vehicle. A width of the further marking can depend on the determined further horizontal distance.

The width of the further marking can correspond to the determined further horizontal distance. This is particularly advantageous if the width of the marking also corresponds to the determined horizontal distance. In this case, two markings are projected in front of the motor vehicle, each marking being as wide as the distance of the motor vehicle from the lane boundaries. A user can determine relatively easily whether the motor vehicle is centered in the lane by comparing the widths of the two markings. If both markings are the same width, the motor vehicle is centered in the lane.

The motor vehicle can comprise a control unit, a camera, and a headlight. The camera is designed to output data to the control unit. The data can be in the form of video or image data, for example. The control unit is designed to use the data to determine a horizontal distance of the motor vehicle from a lane boundary. The control unit is also designed to cause the headlight to project a numerical value. The numerical value depends on the determined horizontal distance.

As an alternative to projecting the numerical value, the control unit can also be designed to cause the headlight to project a marking. A width of the marking depends on the determined horizontal distance.

In addition, the motor vehicle, in particular the headlights and/or the control unit, can be designed to perform various features described above with respect to the method.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic flowchart of a method according to an example of the invention;

FIG. 2 shows a schematic representation of a motor vehicle according to an example of the invention on a roadway with lane boundaries; and

FIG. 3 shows a schematic representation of the motor vehicle from FIG. 2 on the roadway from FIG. 2.

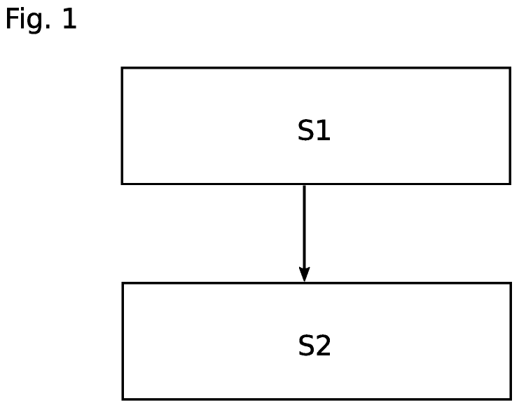

### DETAILED DESCRIPTION

In step S1, the horizontal distance of a motor vehicle from a lane boundary is determined. The lane boundary delimits a lane in which the motor vehicle is located. The lane boundary can be, for example, a road edge or a marking. In addition, a further horizontal distance of the motor vehicle from a further lane boundary is determined. The further lane boundary delimits the lane in a different direction than the lane boundary. Thus, the roadway is located between the two lane boundaries.

In step S2, the distances determined in step S1 are projected onto the roadway in front of the motor vehicle as numerical values or markings by means of one or two headlights of the motor vehicle. The numerical values can correspond to the distances in meters, for example. In particular, it can be advantageous if, for example, a left headlight projects the horizontal distance of the motor vehicle from the left lane boundary and a right headlight projects the horizontal distance of the motor vehicle from the right lane boundary.

When the markings are projected onto the roadway, their respective widths correspond to the distance of the motor vehicle from the lane boundary and the further lane boundary.

It is thus particularly easy for a driver of the motor vehicle to keep the motor vehicle approximately centered within the lane by steering the motor vehicle so that both numerical values are approximately the same or that both markings are approximately the same width.

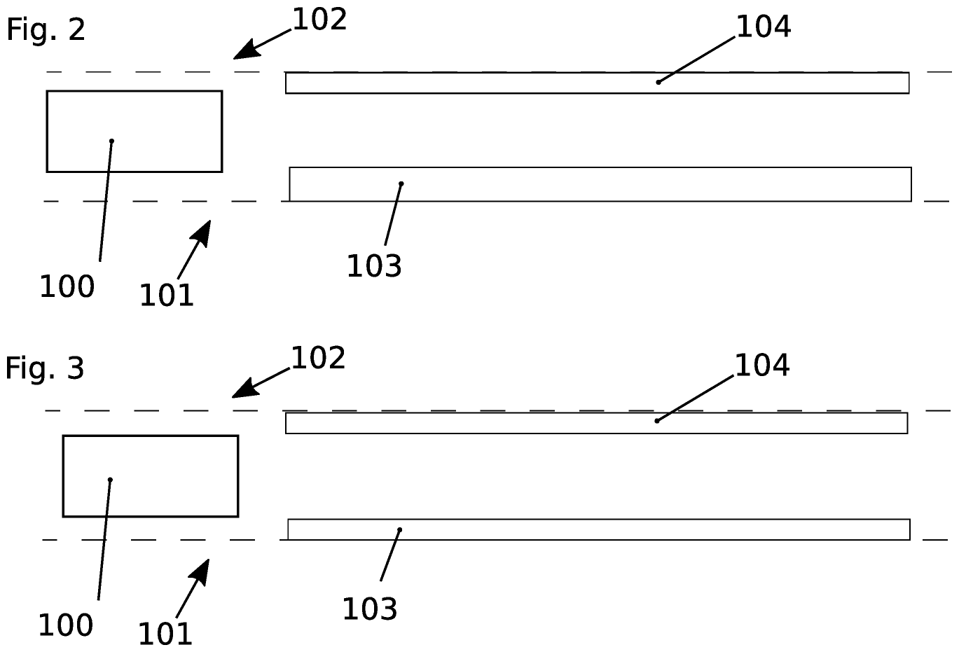

Motor vehicle 100 in FIGS. 2 and 3 is designed to determine its distance from lane boundaries 101 and 102 of a roadway on which it is traveling. In addition, motor vehicle 100 is designed to project a marking 103 onto the roadway. The width of marking 103 corresponds to the determined distance of motor vehicle 100 from lane boundary 101. Motor vehicle 100 is further designed to project a further marking 104 onto the roadway. The width of the further marking 104 corresponds to the distance of motor vehicle 100 from further lane boundary 102.

In FIG. 2, the distance of motor vehicle 100 from lane boundary 101 is greater than the distance of motor vehicle 100 from the further lane boundary 102. Thus, marking 103 is wider than the further marking 104. It is thus particularly easy for the user to realize that motor vehicle 100 is not centered in the lane.

In FIG. 3, the distance of motor vehicle 100 from both lane boundaries 101 and 102 is the same, so that markings 103 and 104 are the same size. Thus, it is easy for the user of motor vehicle 100 to realize that he is centered in his lane.

Markings 103 and 104 are arranged laterally offset relative to motor vehicle 100 so that they fill the areas that lie between motor vehicle 100 and lane boundaries 101 and 102 when the motor vehicle 100 is traveling straight ahead.

The projection of markings 103 and 104 can occur, for example, by means of headlights of motor vehicle 100.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for displaying a horizontal distance of a motor vehicle from a lane boundary, the method comprising:
determining the horizontal distance of the motor vehicle from the lane boundary; and
projecting a numerical value via a headlight of the motor vehicle, the numerical value being based on the determined horizontal distance, or projecting a marking, wherein a width of the marking is based on the determined horizontal distance.

2. The method according to claim 1, wherein the horizontal distance between a lateral end of the motor vehicle and the lane boundary is determined.

3. The method according to claim 1, wherein the numerical value corresponds to the determined distance in meters.

4. The method according to claim 1, wherein the projection is made onto a roadway located in front of the motor vehicle, and wherein the lane is delimited by the lane boundary.

5. The method according to claim 1, wherein only the horizontal distance of the motor vehicle from the lane boundary is determined.

6. The method according to claim 1, wherein the width of the marking corresponds to the determined horizontal distance.

7. The method according to claim 1, wherein a further horizontal distance of the motor vehicle from a further lane boundary is determined, wherein a further numerical value is projected by the headlight or by a further headlight of the motor vehicle, and wherein the further numerical value depends on the determined further horizontal distance.

8. The method according to claim 1, wherein a further horizontal distance of the motor vehicle from a further lane boundary is determined, wherein a further marking is projected by the headlight or by a further headlight of the motor vehicle, and wherein a width of the further marking depends on the determined further horizontal distance.

9. The method according to claim 8, wherein the width of the further marking corresponds to the determined further horizontal distance.

10. A motor vehicle comprising:
a control unit;
a camera; and
a headlight,
wherein the camera is designed to output data to the control unit,
wherein the control unit is designed to use the data to determine a horizontal distance of the motor vehicle from a lane boundary,
wherein the control unit is designed to cause the headlight to project a numerical value,
wherein the numerical value depends on the determined horizontal distance, or to project a marking, and
wherein a width of the marking depends on the determined horizontal distance.
